(19) United States
(12) Patent Application Publication
(10) Pub. No.: US 2011/0286225 A1
(43) Pub. Date: Nov. 24, 2011

(54) LED LIGHTING DEVICE

(75) Inventors: Katsuyuki Konishi, Osaka (JP); Masanori Watanabe, Osaka (JP)

(73) Assignee: Sharp Kabushiki Kaisha, Osaka (JP)

(21) Appl. No.: 13/145,247

(22) PCT Filed: Dec. 10, 2009
(86) PCT No.: PCT/JP2009/070690

§ 371 Date: Jul. 19, 2011

(30) Foreign Application Priority Data
Jan. 20, 2009 (JP) 2009-010338

(51) Int. Cl. F21V 21/096; F21V 21/00

(52) U.S. Cl. 362/398; 362/382

(57) ABSTRACT

An LED lighting device that allows easy attachment, replacement, and cleaning of a lighting apparatus, as compared to a fluorescent lamp, is provided. An LED lighting device 100 includes an LED lighting apparatus 140, and a holder 110 including a holding portion (left holding portion 120 and right holding portion 130) that holds two end portions of the LED lighting apparatus 140 and supplies commercial alternating- or direct-current power to the LED lighting apparatus 140. The state of the LED lighting apparatus 140 relative to the holder 110 can be, in addition to a normal holding state and a separated state, a semi-holding state in which the LED lighting apparatus 140 is held with its one end portion (left end portion 150) being held by the holder 110 (left holding portion 120) and the other end portion (plug 160) being removed from the holder 110.

### TECHNICAL FIELD

The present invention relates to an LED lighting device equipped with a removable LED lighting apparatus and a holder for holding the LED lighting apparatus.

### BACKGROUND ART

With recent improvement in efficiency, LEDs (light emitting diodes) are expected to play a leading part in the field of lighting devices as an energy-saving light source compared to incandescent or fluorescent lamps.

From the viewpoint of making use of conventional facilities for incandescent or fluorescent lamps, incandescent lamp type LEDs (see Patent Document 1, for example) or fluorescent lamp type LEDs (see Patent Document 2, for example) have been proposed as shapes of LED lighting devices using LED elements.

Since the incandescent lamp type LEDs are attachable to and detachable from incandescent lamp sockets (screw-mount sockets) to which commercial alternating-current power is supplied, it is easy to replace current incandescent lamps with the incandescent lamp type LEDs. The fluorescent lamp type LEDs are provided with two pins at each of both ends and configured to receive power from these pins, so they are attachable to current fluorescent-lamp holders.

Commercial alternating-current power is not directly supplied to a fluorescent-lamp holder, but rather supplied thereto via a fluorescent-lamp lighting circuit. Fluorescent lamp type LEDs disclosed in Patent Document 2 are devised to be compatible with any type of fluorescent lighting devices, such as a glow-starter fluorescent lighting device for which the flowing-in of a large current (overcurrent) to a glow starter is prevented, an inverter type fluorescent lighting device for which current detection is enabled between two terminal pins of a base, and a rapid-start fluorescent lighting device for which no trouble is caused.

Patent Document 3 discloses an LED lighting system that includes an illumination part including a long length of LED phosphor driven by DC, and socket parts provided at both ends of the illumination part. By installing a portion for converting AC power into DC current in the ceiling, the system attempts to reduce the weight of the illumination part including the LED phosphor.

### PRIOR ART DOCUMENT

### Patent Document

[Patent Document 1] JP 2002-525814A
[Patent Document 2] JP 2008-277188A
[Patent Document 3] JP 2008-47377A

### SUMMARY OF INVENTION

### Problem to be Solved by the Invention

Since incandescent lamp type LEDs are connected to an incandescent lamp socket, commercial alternating-current power (in general, AC power of 100 to 240 V, although this varies from nation to nation) is supplied directly to an LED lighting device. In contrast, since fluorescent lamp type LEDs are connected to a fluorescent lamp terminal, supplied power is input via a lighting circuit for lighting a fluorescent lamp, such as a stabilizer or an inverter.

Despite the presence of various types of fluorescent lamp lighting circuits as mentioned above, the use of pin-compatible fluorescent lamp type LEDs can cause safety trouble due to the use of different types of lighting circuits or cause energy loss due to the need to pass through such lighting circuits. Furthermore, in the case of Patent Document 2, an extra mechanism is required in order to make LEDs compatible with any types.

Incidentally, fluorescent lamps are currently widely used as lighting devices, and therefore, it is preferable that LED lighting devices are of shapes that are as close as possible to fluorescent lamps in order to spread the use of LED illumination while taking advantage of the facilities and know-how of the fluorescent lamps. In particular, it is considered that LED illumination should inherit the advantages of the fluorescent lamps of being replaceable and of being detachable and thus capable of being removed for cleaning.

An object of the present invention is to provide an LED lighting device that further improves the advantages of conventional fluorescent lamps of being replaceable and of being detachable and thus capable of being removed for cleaning, and improves ease of attachment, detachment, and cleaning of the lighting device, which is generally installed in high ceilings.

### Means for Solving the Problems

An LED lighting device according to the present invention includes an LED lighting apparatus provided with an LED element, and a holder including at least a holding portion that holds the LED lighting apparatus and supplies power to the LED lighting apparatus, wherein a state of connection between the LED lighting apparatus and the holder can be any of a holding state, a semi-holding state, and a separated state, the holding state being a state in which holding places at two end portions of the LED lighting apparatus are held by the holding portion of the holder, the semi-holding state being a state in which one of the holding places at one of the end portions of the LED lighting apparatus is held by the holding portion of the holder, and the separated state being a state in which the LED lighting apparatus and the holder are completely separated from each other.

Preferably, with the LED lighting device according to the present invention, in the semi-holding state, the LED lighting apparatus can be held while hanging down from the holding portion due to its own weight.

Preferably, with the LED lighting device according to the present invention, the LED lighting apparatus includes a power supply connecting portion in one of the holding places at one of the end portions, but does not include a power supply connecting portion in the other holding place at the other end portion.

Preferably, with the LED lighting device according to the present invention, the power supply connecting portion includes at least two connection terminals that have compatibility with a socket for commercial alternating-current power supply, and commercial alternating-current power is supplied from the connection terminals directly to the LED lighting apparatus.

Preferably, with the LED lighting device according to the present invention, the power supply connecting portion also serves as one of the holding places held by the holding portion of the holder.

Preferably, with the LED lighting device according to the present invention, the holding portion is pivotable relative to a holder top plate of the holder.

Preferably, with the LED lighting device according to the present invention, the LED lighting apparatus includes a driving circuit for driving the LED element.

Preferably, with the LED lighting device according to the present invention, the driving circuit converts commercial alternating-current power into current that has a direct-current component when averaged over time.

Preferably, with the LED lighting device according to the present invention, the LED lighting apparatus can be shaped so that during storage, the LED lighting apparatus fits within a portion obtained by extending a virtual rectangular prism circumscribing an external shape of the LED lighting apparatus.

Preferably, with the LED lighting device according to the present invention, a back face of an LED element mounting portion of the LED lighting apparatus is in contact with a holder top plate of the holder.

Preferably, with the LED lighting device according to the present invention, an attracting force of a magnet brings the back face of the LED element mounting portion into contact with the holder top plate.

### Effects of the Invention

According to the present invention, an LED lighting device includes an LED lighting apparatus equipped with an LED element, and a holder for holding both ends of the LED lighting apparatus. The state of the LED lighting apparatus and the holder can be, in addition to a normal holding state and a separated state in which they are completely separated from each other, a semi-holding state in which one end portion of the LED lighting apparatus is held by the holder, whereas the other end portion thereof is removed from the holder. In the semi-holding state, since the LED lighting apparatus is suspended by its one end portion being held and the other end portion hanging down by gravity, the LED lighting apparatus, which is generally installed at high elevations such as a ceiling, can descend to a level that is easy to handle. Accordingly, the LED lighting apparatus in the semi-holding state is easy to clean and easy to replace because an operator can grasp the LED lighting apparatus in that state. Therefore, even if the LED lighting apparatus is installed at high elevations such as a ceiling, an operator is capable of cleaning or replacing the LED lighting apparatus without the need to climb up on a stepladder as in conventional cases.

### BRIEF DESCRIPTION OF DRAWINGS

FIG. 1 is a front view of an LED lighting device of Embodiment 1.

FIG. 2 is a bottom view of the LED lighting device of Embodiment 1.

FIG. 3A is a left hand side view schematically showing a left side face of the LED lighting device of Embodiment 1.

FIG. 3B is a right hand side view schematically showing a right side face of the LED lighting device of Embodiment 1.

FIG. 4A is a front view illustrating removal of the LED lighting device of Embodiment 1.

FIG. 4B is a front view illustrating a semi-holding state during removal of the LED lighting device of Embodiment 1.

FIG. 5 is a right hand side view schematically showing an interrelationship between the LED lighting apparatus and a working rod during removal of the LED lighting apparatus of the LED lighting device of Embodiment 1.

FIG. 6A is a bottom view illustrating a modification of the LED lighting device of Embodiment 1.

FIG. 6B is a right hand side view illustrating the modification of the LED lighting device of Embodiment 1.

FIG. 7 is a front view of an LED lighting device of Embodiment 2.

FIG. 8 is a bottom view of the LED lighting device of Embodiment 2.

FIG. 9A is an explanatory diagram schematically showing attachment of an LED lighting apparatus of the LED lighting device of Embodiment 2, and is a left hand side view showing a holding state with a left holding spring.

FIG. 9B is an explanatory diagram schematically showing attachment of the LED lighting apparatus of the LED lighting device of Embodiment 2, and is a right hand side view showing the holding state with a right holding spring.

FIG. 10A is an explanatory diagram schematically showing a modification of the LED lighting device of Embodiment 2, and is a left hand side view showing a holding state with a left holding spring.

FIG. 10B is an explanatory diagram schematically showing the modification of the LED lighting device of Embodiment 2, and is a right hand side view showing the holding state with a right holding spring.

FIG. 11 is a front view showing a semi-holding state of the LED lighting device of Embodiment 2.

FIG. 12 is a front view of an LED lighting device of Embodiment 3.

FIG. 13 is a bottom view of the LED lighting device of Embodiment 3.

FIG. 14 is a right hand side view schematically showing a right side face of the LED lighting device of Embodiment 3.

FIG. 15 is a front view schematically showing attachment of the LED lighting device of Embodiment 3.

FIG. 16A is an explanatory diagram schematically showing a modification of the LED lighting device of Embodiment 3, and is a front view of an LED lighting apparatus.

FIG. 16B is an explanatory diagram schematically showing the modification of the LED lighting device of Embodiment 3, and is a right hand side view of the LED lighting apparatus.

FIG. 17A is an explanatory diagram schematically showing a semi-holding state of an LED lighting device of Embodiment 4, and is a front view showing the semi-holding state.

FIG. 17B is an explanatory diagram schematically showing the semi-holding state of the LED lighting device of Embodiment 4, and is a front view showing a state during attachment.

FIG. 17C is an explanatory diagram schematically showing the semi-holding state of the LED lighting device of Embodiment 4, and is a front view showing a holding state.

FIG. 18 is a right hand side view schematically showing a holding state of the LED lighting device of Embodiment 4 with a right holding portion.

FIG. 19A is an explanatory drawing schematically showing a holding state of the LED lighting device of Embodiment 4 with a left holding portion, and is a left hand side view showing the holding state.

FIG. 19B is an explanatory drawing schematically showing the holding state of the LED lighting device of Embodiment 4 with the left holding portion, and is a left hand side view showing a state during insertion.

FIG. 20A is an explanatory drawing schematically showing a semi-holding state of an LED lighting device of Embodiment 5, and is a front view showing the semi-holding state.

FIG. 20B is an explanatory drawing schematically showing the semi-holding state of the LED lighting device of Embodiment 5, and is a front view showing a state during pushing-in of a left end portion.

FIG. 20C is an explanatory drawing schematically showing the semi-holding state of the LED lighting device of Embodiment 5, and is a front view showing a holding state.

FIG. 21 is a right hand side view schematically showing a right side face of the LED lighting device of Embodiment 5.

FIG. 22 is a front view of an LED lighting device of Embodiment 6.

FIG. 23 is a bottom view of the LED lighting device of Embodiment 6.

FIG. 24 is a right hand side view of the LED lighting device of Embodiment 6.

FIG. 25 is a bottom view showing a modification of the LED lighting device of Embodiment 6.

### MODE FOR CARRYING OUT THE INVENTION

### Embodiment 1

### Holding State and Semi-Holding State of LED Lighting Apparatus

An LED lighting device according to the present embodiment is devised, focusing on a point that an LED lighting apparatus using an LED element imposes less constraints on the position of a power supply connection plug than conventional fluorescent tubes. The present embodiment thus provides an LED lighting device equipped with an LED lighting apparatus that includes a place serving as both a power supply connection plug and a holding place at one end portion and another holding place at the other end portion, and that can be in a semi-holding state.

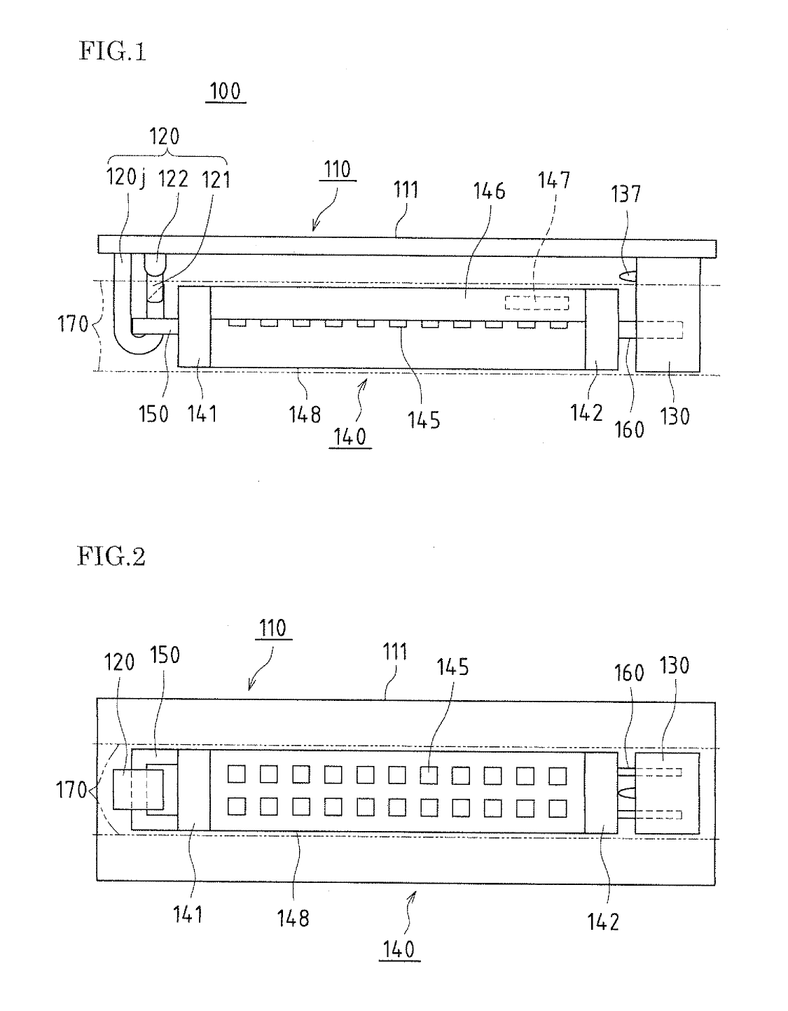

The following is a description of an LED lighting device 100 of Embodiment 1 with reference to FIGS. 1 to 6. FIG. 1 is a front view of the LED lighting device 100 in normal use (holding state), and FIG. 2 is a bottom view of the LED lighting device 100 in normal use (holding state). In the present embodiment, it is assumed that the LED lighting device 100 is substantially horizontally installed in a ceiling located at a level higher than the ordinary human stature. It is, however, noted that the LED lighting device may be installed at an angle along an inclined ceiling, or may be installed with a slight tilt in order to irradiate a portion away from a pole to which the lighting device is attached, such as in the case of street lighting.

As shown in FIG. 1, the LED lighting device 100 is broadly configured by a holder 110 and an LED lighting apparatus 140. The holder 110 includes a left holding portion 120 (a left holding body 120j and left holding fasteners 121 and 122) on the left side of a holder top plate 111 and a right holding portion 130 on the right side of the holder top plate 111, and is configured such that power supply to the LED lighting apparatus 140 comes from one side, specifically, a plug 160 connected to the right holding portion 130.

Also, a release button 137 is disposed in the right holding portion 130. A left reinforcing portion 141 and a right reinforcing portion 142 are coupled to both ends of a base portion 146. The left reinforcing portion 141 has a left end portion 150 disposed thereon. The base portion 146 with LED elements 145 mounted thereon includes therein a driving circuit 147 for driving the LED elements 145. The LED lighting apparatus 140 has a cover 148 that protects it within a range of an external tangent 170.

As mentioned above, the LED lighting apparatus 140 has the multiple LED elements 145 attached to the base portion 146. The details of the LED lighting apparatus 140 will be discussed later.

Left Holding Portion

The left holding portion 120 that holds the left end portion 150 (end portion) of the LED lighting apparatus 140 is constituted by the left holding body 120j having a shape of the letter J and the left holding fasteners 121 and 122 that are disposed to close the opening of the J-shape, as shown in FIG. 1. The left holding fastener 121 is pressed against the left holding body 120j by spring force with the left holding fastener 122 as the fulcrum. When detaching the LED lighting apparatus 140, the left end portion 150 serving as a holding place (end portion) is removed by pressing in the left holding fastener 121 so as to make an opening between the left holding body 120j and the left holding fastener 122. The left end portion 150 is in the shape of a loop as shown in FIG. 2.

While the left holding fasteners 121 and 122 serve to prevent the LED lighting apparatus 140 from falling off from the left holding portion 120 even in the presence of vibrations or the like, a configuration is also possible in which the left holding portion 120 is constituted by only the left holding body 120j by minimizing the distance between the left holding body 120j and the holder top plate 111 in order to eliminate the risk of falling off.

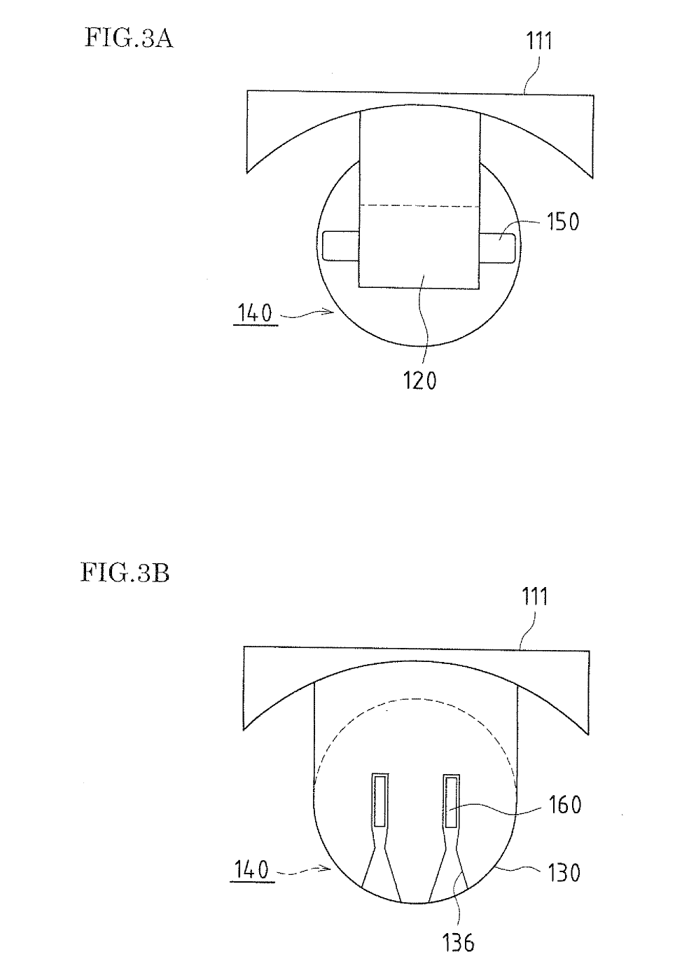

FIG. 3 shows side faces of the LED lighting device 100 of Embodiment 1. FIG. 3A is a left hand side view of the LED lighting device 100 in the holding state, showing how the left end portion 150 of the LED lighting apparatus 140 is being held. The left holding portion 120 is shaped to be capable of hanging the loop-shaped left end portion 150 thereon. Accordingly, the LED lighting apparatus 140 is held by the left holding portion 120 due to its own weight.

Right Holding Portion

FIG. 3B is a right hand side view of the LED lighting device 100 in the holding state, showing how the plug 160 of the LED lighting apparatus 140, which is a holding place at the right end portion (end portion), is being held. The right holding portion 130 coupled to the holder top plate 111 is provided with plug insertion openings 136 that enable the plug 160 to be inserted from below (from the floor side), and also includes therein a spring mechanism in order to firmly press and hold the inserted plug 160.

Since commercial alternating-current power is supplied directly to the plug 160 through the plug insertion openings 136 without the intervention of a circuit or the like that is conventionally required for lighting of a fluorescent lamp, there is no problem such as power loss due to such an intervening circuit or a difficulty in fitting the lighting apparatus to such a circuit. In other words, the plug 160 serves as a power supply connecting portion and includes at least two connection terminals that have compatibility with a socket for commercial alternating-current power supply.

Removal of LED Lighting Apparatus

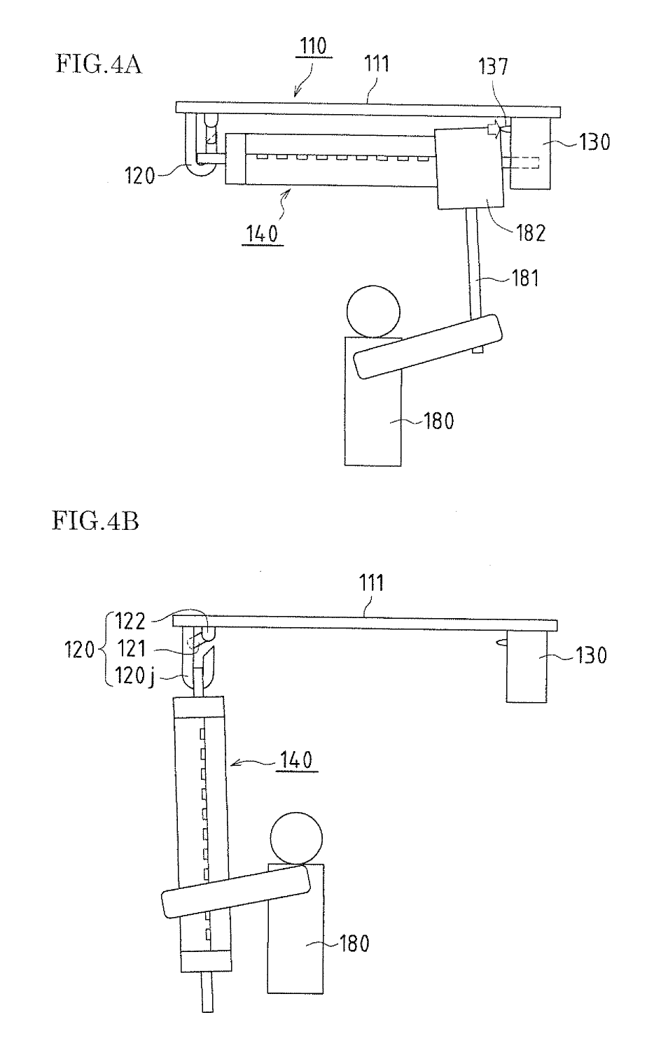

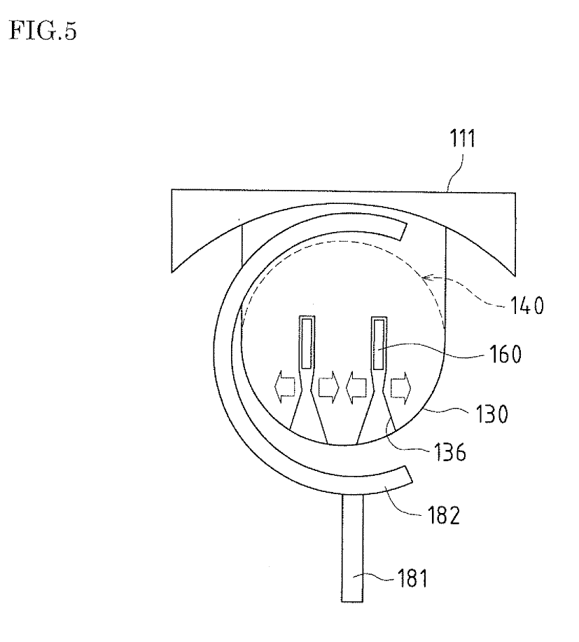

FIG. 4A is a front view showing a process of removing the LED lighting apparatus 140 from the holder 110. FIG. 5 is a right hand side view schematically showing an interrelationship between the LED lighting apparatus 140 and a working rod 181 during removal of the LED lighting apparatus 140.

An operator 180 hangs a working rod tip 182 of the working rod 181 on the right end of the LED lighting apparatus 140 as shown in FIG. 5 and presses the release button 137 (see the hollow arrow in FIG. 4A). This loosens the spring mechanism, with which the plug 160 has been fixed, in the plug insertion openings 136 (see hollow arrows in FIG. 5), and the plug 160 is removed from the plug insertion openings 136.

If the plug 160 is pulled and the working rod 181 is removed, the LED lighting apparatus 140 assumes a semi-holding state. The “semi-holding state” as used herein refers to a state in which, for a short period of time required for, for example, replacement or cleaning, the LED lighting apparatus 140 is securely held only by the holding portion on one side (the left holding portion 120) without any support of the operator. FIG. 4B shows the semi-holding state. In this state, the left end portion 150 of the LED lighting apparatus 140 is hung (pivotally held) on the left holding portion 120 (left holding body 120j), so the LED lighting apparatus 140 hangs down substantially vertically due to its own weight with the left holding portion 120 (left holding body 120j) as the fulcrum. Accordingly, in this semi-holding state, the operator 180 can easily perform the process of cleaning, attachment, or replacement without the need to climb up on a stepladder, for example.

LED Lighting Apparatus

As shown in FIGS. 1 and 2, the LED lighting apparatus 140 includes the multiple LED elements 145 attached to the base portion 146. The LED elements 145 are covered with the transparent or semi-transparent cover 148 that protects the LED elements 145 and controls distribution of light as necessary. The cover 148 may also serve as a lens or a prism. The left reinforcing portion 141 and the right reinforcing portion 142 connected to the both ends of the base portion 146 are in the shape of a circular cylinder in order to improve the reinforcing strength and make it easy to hold the cover 148.

Although the LED elements 145 are arrayed in two rows in FIG. 2, they may be arrayed in a single row or in three or more rows, or they may be arranged in different arrangements (e.g., a staggered arrangement) other than in rows. Still alternatively, the LED elements 145 may be attached to an inclined face of a base portion provided with a raised portion in order to expand a range of illumination light, or may be installed on the reflecting holder top plate 111 in order to reflect light.

The LED lighting apparatus 140 has a length of, for example, 1198 mm and a pipe diameter of, for example, 25 mm, which is the same as the fluorescent tubes of type Hf32W. The entire mechanism of the LED lighting apparatus 140 is configured to fit within the range of the external tangent 170 (see FIGS. 1 and 2) so that, like conventional fluorescent tubes, it does not require storage space.

The base portion 146 with the LED elements 145 attached thereto has mounted therein the driving circuit 147 (not visible from outside) for driving the LED elements 145. The driving circuit 147 converts commercial alternating-current power supplied from the plug 160 into driving current based on direct current, PWM (pulse width modulation), or half-wave rectification suitable for driving of the LED elements 145, that is current having a direct-current component when averaged over time.

Optionally, a light control circuit for adjusting the brightness of LEDs, a sensor circuit for detecting humans, an optical sensor for adjusting the brightness of LEDs in accordance with the ambient brightness, a remote-controlled light receiving unit, a light illumination communication circuit using the LED elements 145, or a power-line communication circuit may be mounted as necessary for control of the LED elements 145.

The life time of the LED elements 145, which is extremely long as compared with conventional incandescent or fluorescent lamps, is for example 40,000 hours (13.7 years for 8 hour lighting per day and 4.6 years for 24 hour lighting), and the safety guaranteed life time of the driving circuit 147, which uses large amounts of power, is also in the order of 40,000 hours (actual operation) or 10 years (life time with aged deterioration), for example. Accordingly, the integration of the LED elements 145 and the driving circuit 147 in the LED lighting apparatus 140 has the advantage of enabling simultaneous replacement.

LED Elements

The LED elements 145 used are obtained by disposing a single or several blue LED chips in a single package and sealing the package with a resin combined with phosphors that are excited by light emitted from the blue LED chip(s) and emit green and red light. The LED elements 145 may also be a combination of blue, green, and red LED chips (multicolor LEDs), and in this case, a high-value-added LED lighting device is achieved because of the capability of changing illumination color.

The LED elements 145 may also be a combination of blue LEDs and a yellow phosphor, which is suitable for lighting, such as outdoor lighting, that does not require color rendering properties, since in this case, high luminance is obtained because of high human luminosity factor of yellow color.

Favorable examples of phosphors include BOSE (Ba, O, Sr, Si, Eu), SOSE (Sr, Ba, Si, O, Eu), YAG (Ce-activated yttrium aluminum garnet), α-SiAlON ((Ca), Si, Al, O, N, Eu), β-SiAlON (Si, Al, O, N, Eu), and CASN (CaAlSiN₃:Eu).

### Modification of Embodiment 1

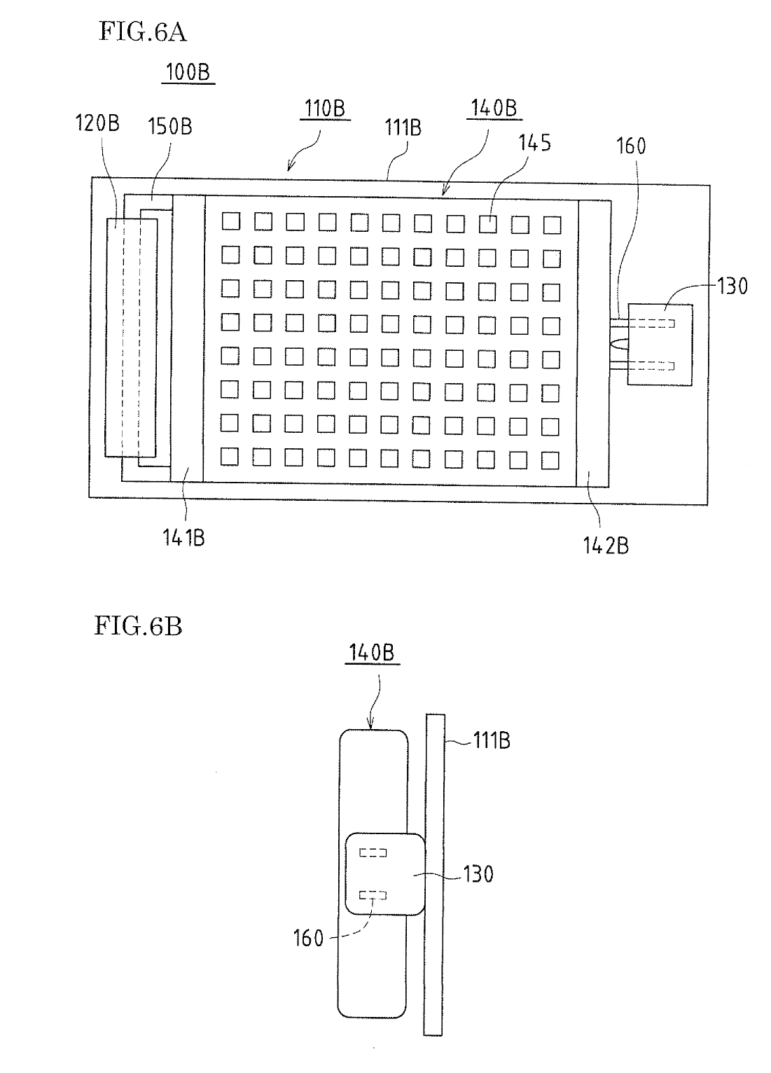

FIG. 6A is a bottom view for the case of using an LED lighting apparatus 140B that is wider than the LED lighting apparatus 140. FIG. 6B is a right hand side view thereof. The basic configuration is similar to that of the LED lighting device 100 and the LED lighting apparatus 140 shown in FIGS. 1 and 2, and therefore only an outline of the configuration is shown herein.

An LED lighting device 100E includes a holder 110B, a holder top plate 111B, a left holding portion 120B, and, a right holding portion 130. The LED lighting apparatus 140B includes a left reinforcing portion 141B, a right reinforcing portion 142B, a left end portion 150B, and a plug 160.

The left end portion 150B serving as a holding place and the left holding portion 120B are greater in length in the width direction. The LED lighting apparatus 140B has the same front shape as shown in FIG. 1, but has a side shape with rounded corners as shown in FIG. 6B.

The advantages and other features of such a wide LED lighting apparatus will be discussed later (see Embodiment 6).

As described above, the LED lighting device 100 according to the present embodiment includes the LED lighting apparatus 140 equipped with the LED elements 145, and the holder 110 including at least a holding portion (the right holding portion 130) that holds the LED lighting apparatus 140 and supplies power to the LED lighting apparatus 140. The state of connection between the LED lighting apparatus 140 and the holder 110 can be in any of a holding state, a semi-holding state, and a separated state, the holding state being a state in which the holding places (the left end portion 150 and the plug 160) at the two end portions (the left end portion 150 and the plug 160 serving as a right end portion) of the LED lighting apparatus 140 are held by the holding portions (the left holding portion 120 and the right holding portion 130) of the holder 110, the semi-holding state being a state in which one of the holding places (the left end portion 150) at one end portion (e.g., the left end portion 150) of the LED lighting apparatus 140 is held by one holding portion (the left holding portion 120) of the holder 110, and the separated state being a state in which the LED lighting apparatus 140 and the holder 110 are completely separated from each other.

With the LED lighting device 100 according to the present embodiment, in the semi-holding state, the LED lighting apparatus 140 can be supported while hanging down from the holding portion (e.g., the left holding body 120j of the left holding portion 120) due to its own weight.

Furthermore, with the LED lighting device 100 according to the present embodiment, the LED lighting apparatus 140 includes a power supply connecting portion (the plug 160) in one of the holding places (the plug 160) at one end portion (e.g., the right end portion), but does not include a power supply connecting portion in the other holding place (the left end portion 150) at the other end portion (the left end portion 150).

Furthermore, with the LED lighting device 100 according to the present embodiment, the power supply connecting portion (the plug 160) includes at least two connection terminals that have compatibility with a socket for commercial alternating-current power supply, and commercial alternating-current power is supplied from the connection terminals directly to the LED lighting apparatus 140.

Furthermore, with the LED lighting device 100 according to the present embodiment, the power supply connecting portion (the plug 160) also serves as one of the holding places held by the holding portion (the right holding portion 130) of the holder 110.

Furthermore, with the LED lighting device 100 according to the present embodiment, the LED lighting apparatus 140 includes the driving circuit 147 for driving the LED elements 145.

Furthermore, with the LED lighting device 100 according to the present embodiment, the driving circuit 147 converts commercial alternating-current power into current that has a direct-current component when averaged over time.

### Embodiment 2

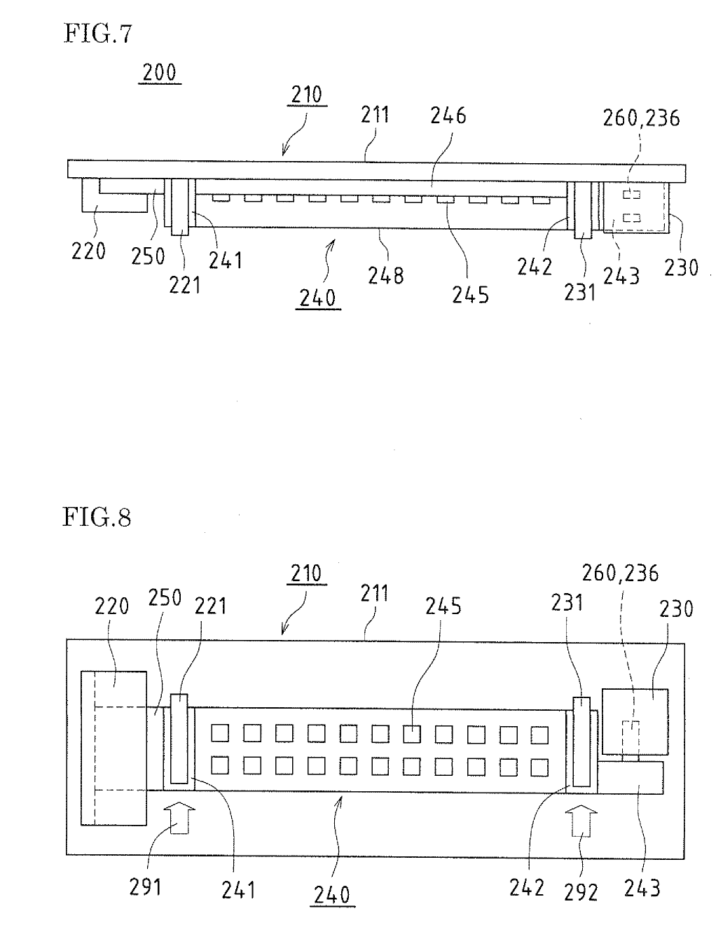

The following is a description of an LED lighting device 200 of Embodiment 2 with reference to FIGS. 7 to 11. Members referenced by 200 numbers in the figures correspond respectively to the members having the same lower two digits and referenced by 100 numbers unless otherwise specified.

Specifically, the LED lighting device 200 includes a holder 210, a holder top plate 211, a left holding portion 220, a right holding portion 230, and plug insertion openings 236. An LED lighting apparatus 240 includes a left reinforcing portion 241, a right reinforcing portion 242, LED elements 245, a base portion 246, a cover 248, a left end portion 250, and a plug 260. Other parts of the basic configuration are similar to those of Embodiment 1, and therefore the following description primarily focuses on the main parts of the configuration.

FIG. 7 is a front view of the LED lighting device 200 in the holding state. The LED lighting apparatus 240 has the LED elements 245 arrayed in the base portion 246 and is covered with the cover 248. The left reinforcing portion 241 and the right reinforcing portion 242 are on the left and right sides of the LED lighting apparatus 240. The left end portion 250, serving as a plate-like holding place, on the left side of the left reinforcing portion 241 is attached into the space between the left holding portion 220 and the holder top plate 211.

The plug 260 for power supply is on the right side of the right reinforcing portion 242, serving also as a holding place attached to the right holding portion 230. The left reinforcing portion 241 is attached so as to be pressed against the holder top plate 211 by a left holding spring 221, and the right reinforcing portion 242 is attached so as to be pressed against the holder top plate 211 by a right holding spring 231. Since the back face of the base portion 246 serving as an LED element mounting portion of the LED lighting apparatus 240 is in contact with the holder top plate 211, heat generated in the LED lighting apparatus 240 can be efficiently conducted (dissipated) into the holder top plate 211.

FIG. 8 is a bottom view of the LED lighting device 200 in the holding state. The LED lighting apparatus 240 is inserted from the openings of the left holding spring 221 and the right holding spring 231 in the direction indicated by arrows 291 and 292. In this case, the plug 260 serving as a holding place at the right end portion is inserted into the plug insertion openings 236 in the right holding portion 230. Note that a plug support portion 243 is disposed between the right reinforcing portion 242 and the plug 260.

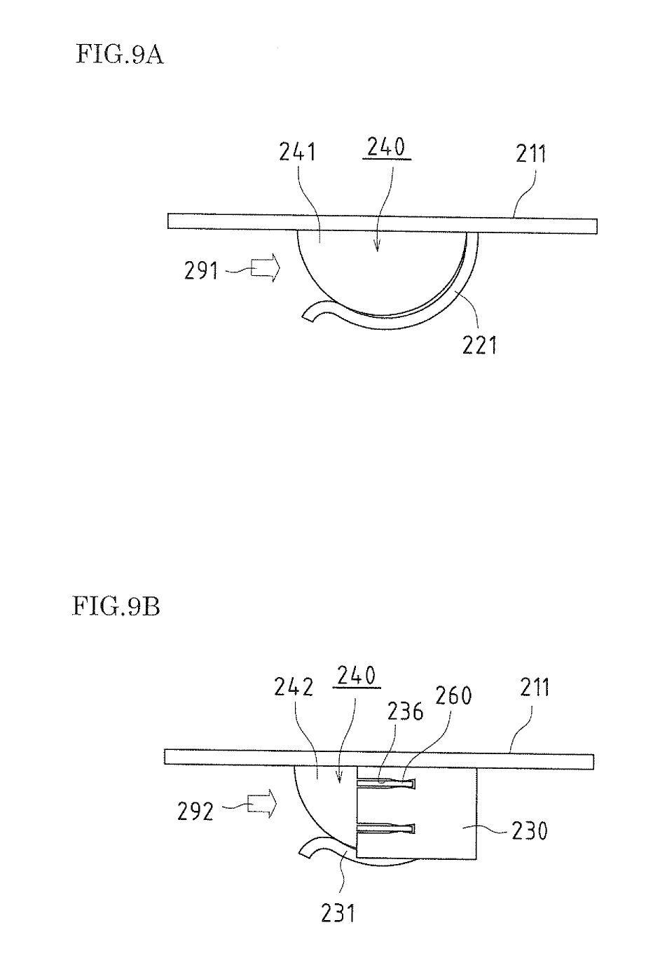

FIG. 9A is a left hand side view showing the holding state of the LED lighting apparatus 240 of the LED lighting device 200, focusing on a portion around the left holding spring 221. The LED lighting apparatus 240 is inserted from the opening of the left holding spring 221 in the direction indicated by the arrow 291 so that the left reinforcing portion 241 is held by the left holding spring 221. FIG. 9B is a right hand side view showing the holding state of the LED lighting apparatus 240, focusing on a portion around the right holding portion 230. The LED lighting apparatus 240 is inserted from the opening of the right holding spring 231 in the direction indicated by the arrow 292 so that the right reinforcing portion 242 is held by the right holding spring 231. In other words, the plug 260 is inserted in the plug insertion openings 236 of the right holding portion 230 by sliding the right reinforcing portion 242 in the direction indicated by the arrow 292. Note that, for ease of understanding, the side views are schematically drawn so that the directions of insertion of the LED lighting apparatus 240 match (the same applies below).

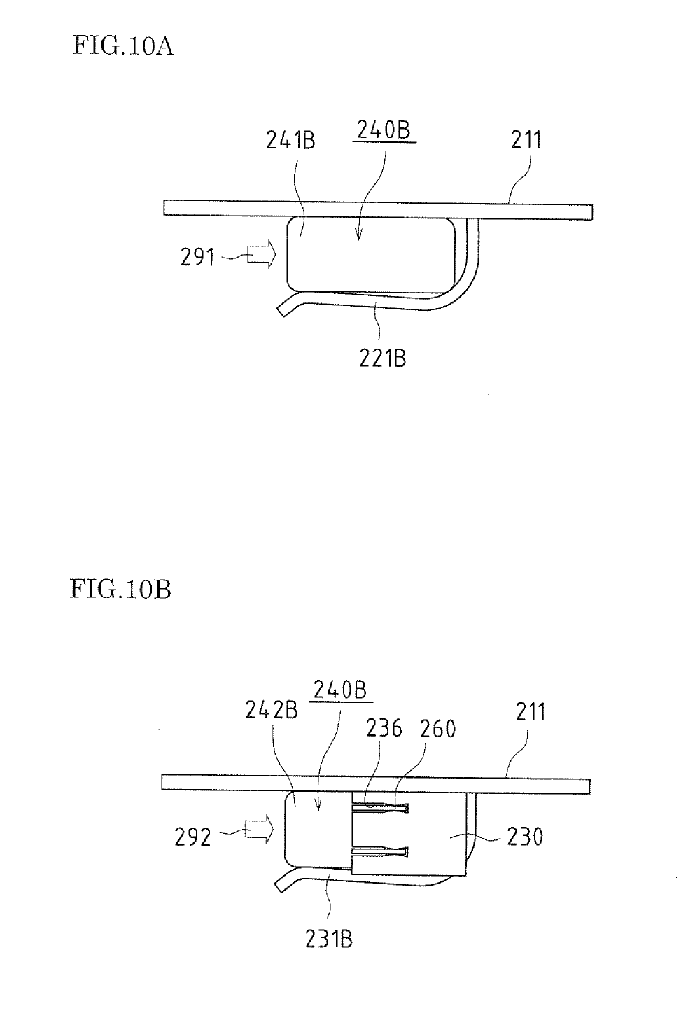

By the action of the left holding spring 221 and the right holding spring 231, the LED lighting apparatus 240 is pressed against the holder top plate 211. Note that the cross-sectional shape of the LED lighting apparatus is not limited to semi-circular, but may be other shapes such as square (see FIG. 10). Furthermore, the underside (the side facing the floor face) of the LED lighting apparatus may be provided with multiple inclined faces.

As a modification of Embodiment 2, the holding state in the case of using an LED lighting apparatus 240B of a square cross-sectional shape is shown in the side views of FIGS. 10A and 10B, which correspond respectively to FIGS. 9A and 9B. In accordance with the shape of the LED lighting apparatus 240B, a left reinforcing portion 241B, a right reinforcing portion 242B, the shapes of a left holding spring 221B, and a right holding spring 231B are slightly changed in shape from those in FIG. 9.

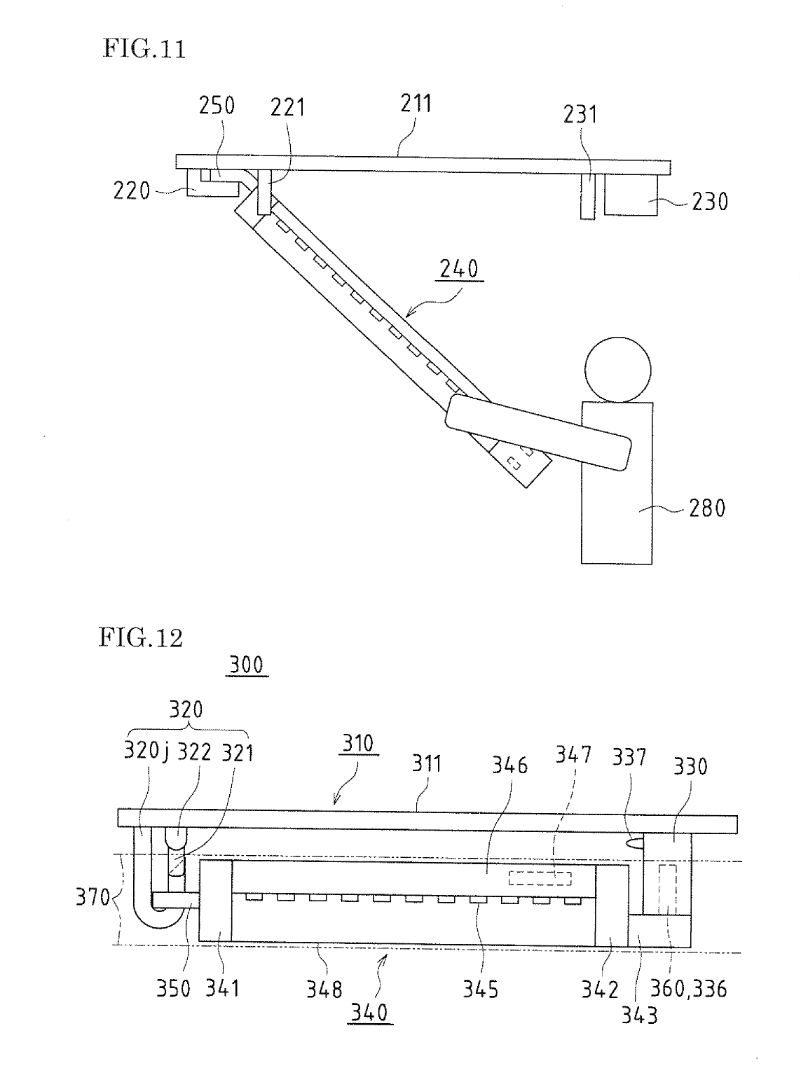

FIG. 11 is an explanatory drawing illustrating the semi-holding state of the LED lighting device 200 (LED lighting apparatus 240). The left end portion 250 serving as a holding place of the LED lighting apparatus 240 is inserted in the space between the left holding portion 220 and the holder top plate 211. Since the left end portion 250 is bendable, it is easy for an operator 280 to perform the process of attachment, cleaning, or removal of the LED lighting apparatus 240 in the semi-holding state. Note that a similar semi-holding state can also be achieved with a configuration in which the left end portion 250 is not bendable, but the holding portion 220 is pivotable.

As described above, with the LED lighting device 200 according to the present embodiment, the back face of the LED element mounting portion (the base portion 246) of the LED lighting apparatus 240 is in contact with the holder top plate 211 of the holder 210.

### Embodiment 3

The following is a description of an LED lighting device 300 of Embodiment 3 with reference to FIGS. 12 to 16. Members referenced by 300 numbers in the figures correspond respectively to the members having the same lower two digits and referenced by 100 numbers unless otherwise specified.

Specifically, the LED lighting device 300 includes a holder 310, a holder top plate 311, a left holding portion 320, a left holding body 320j, left holding fasteners 321 and 322, a right holding portion 330, plug insertion openings 336, and a release button 337. An LED lighting apparatus 340 includes a left reinforcing portion 341, a right reinforcing portion 342, LED elements 345, a base portion 346, a driving circuit 347, a cover 348, a left end portion 350, and a plug 360. Other parts of the basic configuration are similar to those of Embodiment 1, and therefore the following description primarily focuses on the main parts of the configuration.

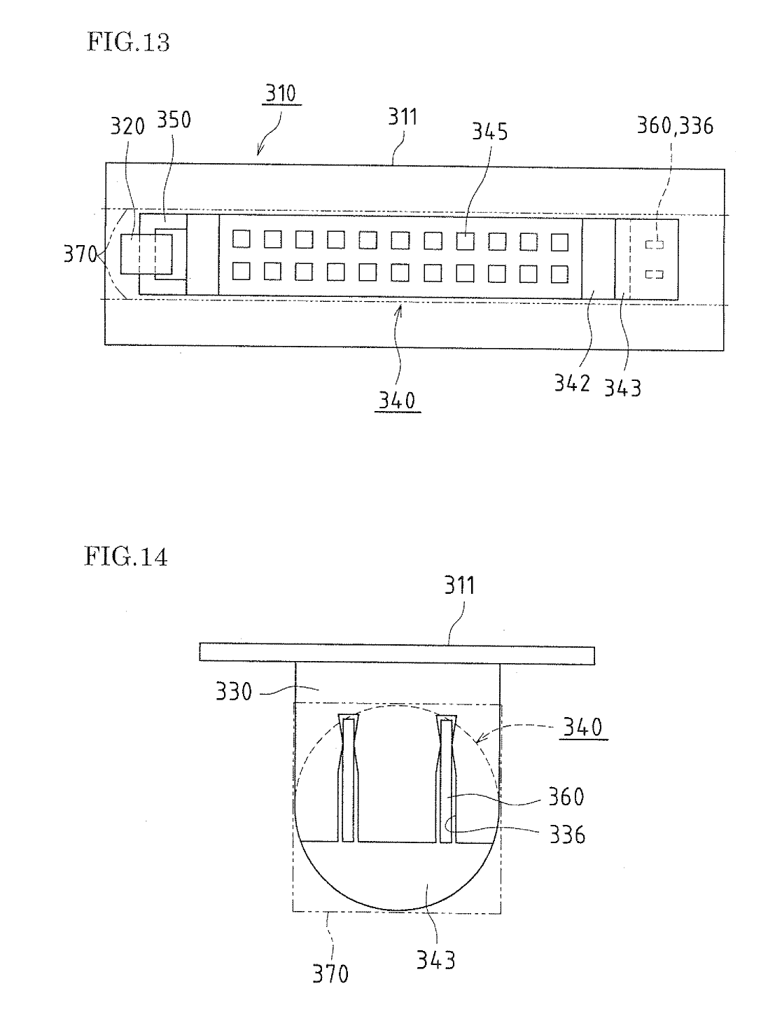

In the LED lighting device 300 of Embodiment 3, as shown in the front view of FIG. 12 and the bottom view of FIG. 13 showing the holding state, the plug 360 that faces upward (in the direction facing the holder top plate 311) in FIG. 12 is provided at the right end portion of the LED lighting apparatus 340. The plug 360 also serves as a holding place and is connected to the right reinforcing portion 342 of the LED lighting apparatus 340 via a plug support portion 343. The left holding body 320j and the left holding fasteners 321 and 322, which form the left holding portion 320, have the same shapes as the left holding body 120j and the left holding fasteners 121 and 122, and the left end portion 350 has the same shape as the left end portion 150. Note that the LED lighting apparatus 340 is of such an external shape as to fit within a range corresponding to a circumscribed rectangular prism 370 (see FIG. 14).

FIG. 14 shows the holding state as viewed from the right side of the right holding portion 330 and other portions. The plug 360 is inserted in the plug insertion openings 336 in the right holding portion 330 fixed to the holder top plate 311, and the LED lighting apparatus 340 is held by the spring function of the plug insertion openings 336.

In the present embodiment, the plug 360 is configured to fit within the circumscribed rectangular prism 370 circumscribing the outer circumference of the LED lighting apparatus 340. Although the plug 360 slightly protrudes outside the outer circumference of the LED lighting apparatus 340 because of its long length, it fits within the circumscribed rectangular prism 370 circumscribing the outer circumference, so that it is possible to house and store the LED lighting apparatus 340 in a box formed in accordance with the circumscribed rectangular prism 370 circumscribing the outer circumference of the LED lighting apparatus 340. Accordingly, storage space can be saved.

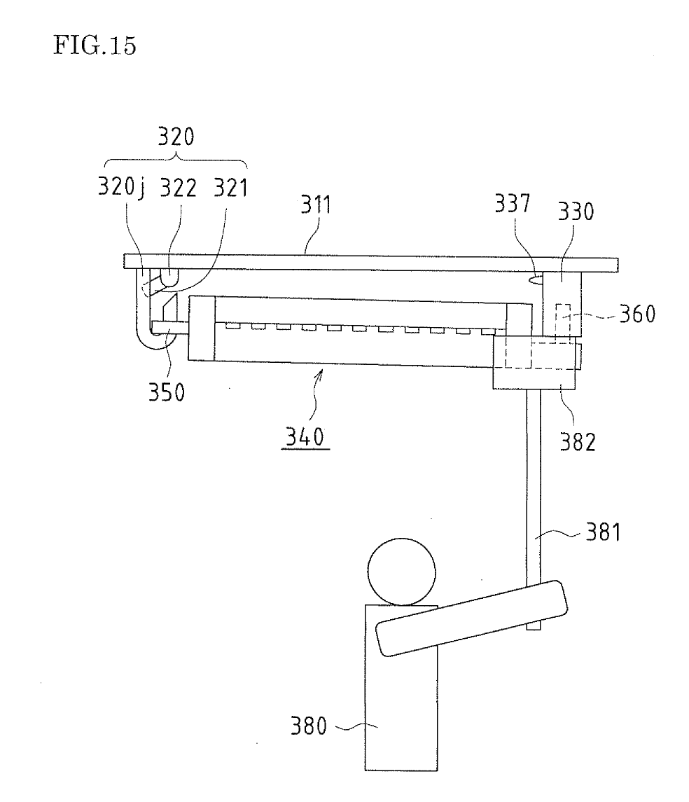

FIG. 15 is an explanatory diagram illustrating how the LED lighting apparatus 340 is attached. An operator 380 pushes in the holder 321 by pressing the left end portion 350 against the holder 321 and hangs the left end portion 350 on the left holding body 320j. Next, the operator 380 supports the LED lighting apparatus 340 with a working rod 381 (a working rod tip 382) and inserts the plug 360 into the plug insertion openings 336 of the right holding portion 330. When fully inserted in the plug insertion openings 336, the plug 360 is fixed and cannot be removed unless the release button 337 is pressed.

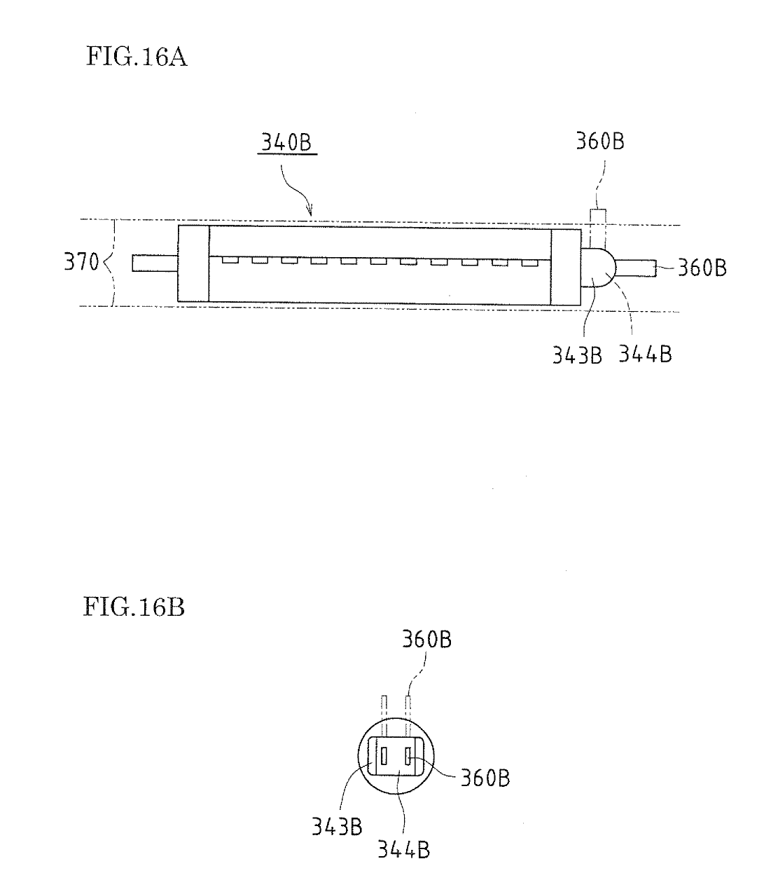

As a modification of Embodiment 3, a front view of an LED lighting apparatus 340B is shown in FIG. 16A, and a right hand side view thereof is shown in FIG. 16B. A plug 360B fixed to a movable portion 344B connected to a plug support portion 343B is pivotable with the rotation of the movable portion 344B, and is located in a position indicated by the solid line during storage and located in a position indicated by the broken line during attachment. Therefore, the plug 360E fits within the circumscribed rectangular prism 370, which circumscribes the outer circumference of the LED lighting apparatus 340B, during storage. Accordingly, the plug portion is not bulky and storage space can be saved during storage of the removed LED lighting apparatus.

As described above, with the LED lighting device 300 according to the present embodiment, the LED lighting apparatus 340 can be shaped so as to fit, during storage, within a portion (the circumscribed rectangular prism 370) obtained by extending a virtual rectangular prism circumscribing the external shape of the LED lighting apparatus.

### Embodiment 4

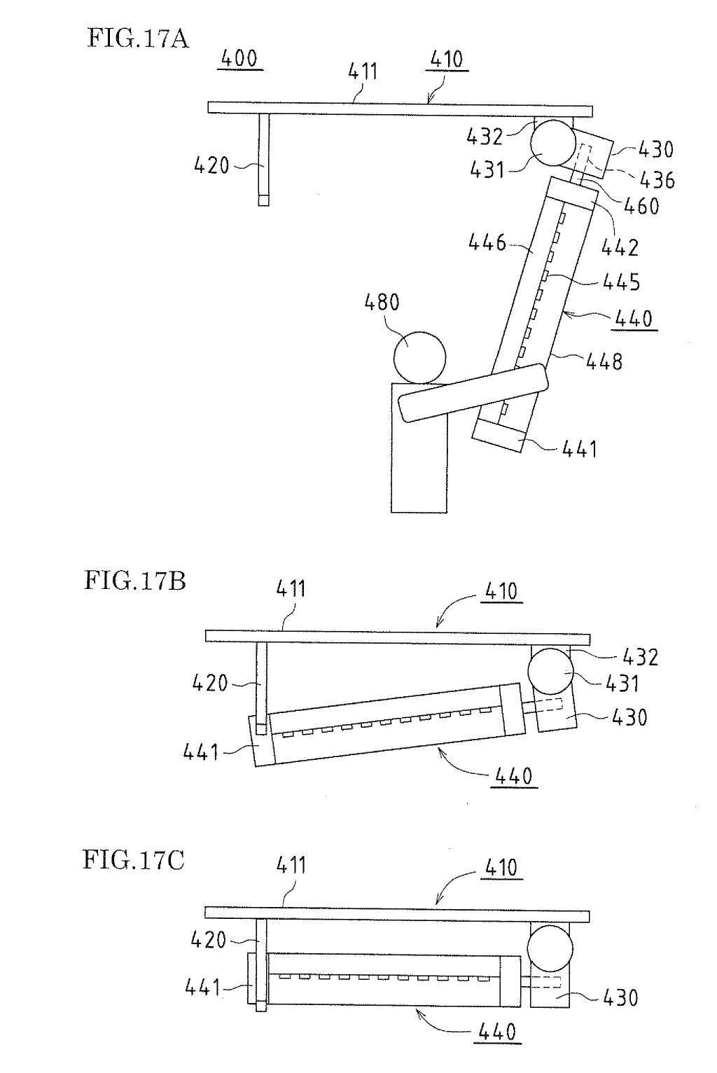

The following is a description of an LED lighting device 400 of Embodiment 4 with reference to FIGS. 17 to 19. Members referenced by 400 numbers in the figures correspond respectively to the members having the same lower two digits and referenced by 100 numbers unless otherwise specified.

Specifically, the LED lighting device 400 includes a holder 410, a holder top plate 411, a left holding portion 420, a right holding portion 430, and plug insertion openings 436. An LED lighting apparatus 440 includes a left reinforcing portion 441, a right reinforcing portion 442, LED elements 445, a base portion 446, a cover 448, and a plug 460. Other parts of the basic configuration are similar to those of Embodiment 1, and therefore the following description primarily focuses on the main parts of the configuration.

In the LED lighting device 400 of Embodiment 4, the right holding portion 430 serving also as a power supply connecting portion is pivotable. Since the right holding portion 430 is pivotable, the LED lighting apparatus 440 can be brought into the semi-holding state by the right holding portion 430, a right holding and pivoting portion 431, and a right holding and fixed portion 432 as shown in FIG. 17A.

Specifically, the right holding portion 430 is configured to be pivotable via the right holding and pivoting portion 431 supported by the right holding and fixed portion 432. Accordingly, the LED lighting apparatus 440 is hung down vertically from the right holding and fixed portion 432 fixed to the holder top plate 411, with the right holding and pivoting portion 431 and the right holding portion 430 as the fulcrum.

As shown in FIG. 17A, an operator 480 inserts the plug 460 into the right holding portion 430 while holding the LED lighting apparatus 440 vertically. The plug 460 serving also as a holding place is weakly held by the interfacial friction at the plug insertion openings 436 in the right holding portion 430, but is not securely fixed to an extent that the weight of the LED lighting apparatus 440 can be supported.

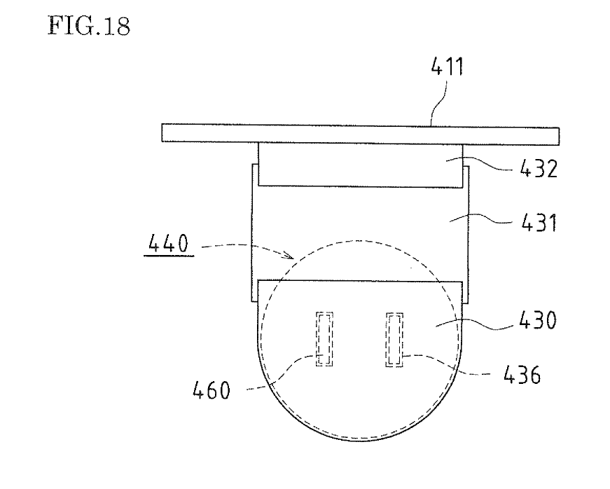

As schematically shown in the right hand side view of FIG. 18, the plug 460 is inserted in the plug insertion openings 436 in the right holding portion 430. The right holding portion 430 is coupled to the holder top plate 411 via the right holding and pivoting portion 431 and the right holding and fixed portion 432.

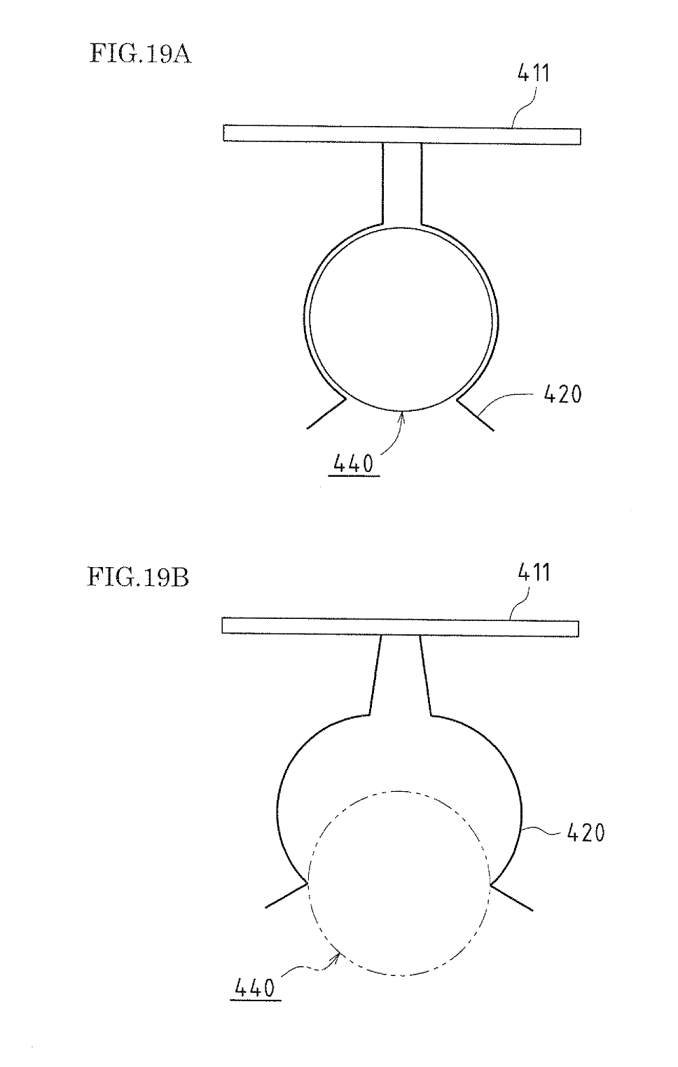

Next, as shown in FIG. 17B, the left reinforcing portion 441 serving as a holding place of the LED lighting apparatus 440 is fitted in the left holding portion 420 of the holder 410. The left holding portion 420 has a cross-sectional shape as shown in FIG. 19A, and holds the LED lighting apparatus 440 by spring force. The left holding portion 420 is opened by spring force, as shown in FIG. 19B, during insertion of the LED lighting apparatus 440.

With this attachment operation, the LED lighting apparatus 440 is held by the holder 410 as shown in FIG. 17C.

In the present embodiment, the attachment, cleaning, and replacement of the LED lighting apparatus 440 can be easily performed in the semi-holding state shown in FIG. 17A.

As described above, with the LED lighting device 400 according to the present embodiment, the holding portion (the right holding portion 430) is pivotable relative to the holder top plate 411 of the holder 410.

### Embodiment 5

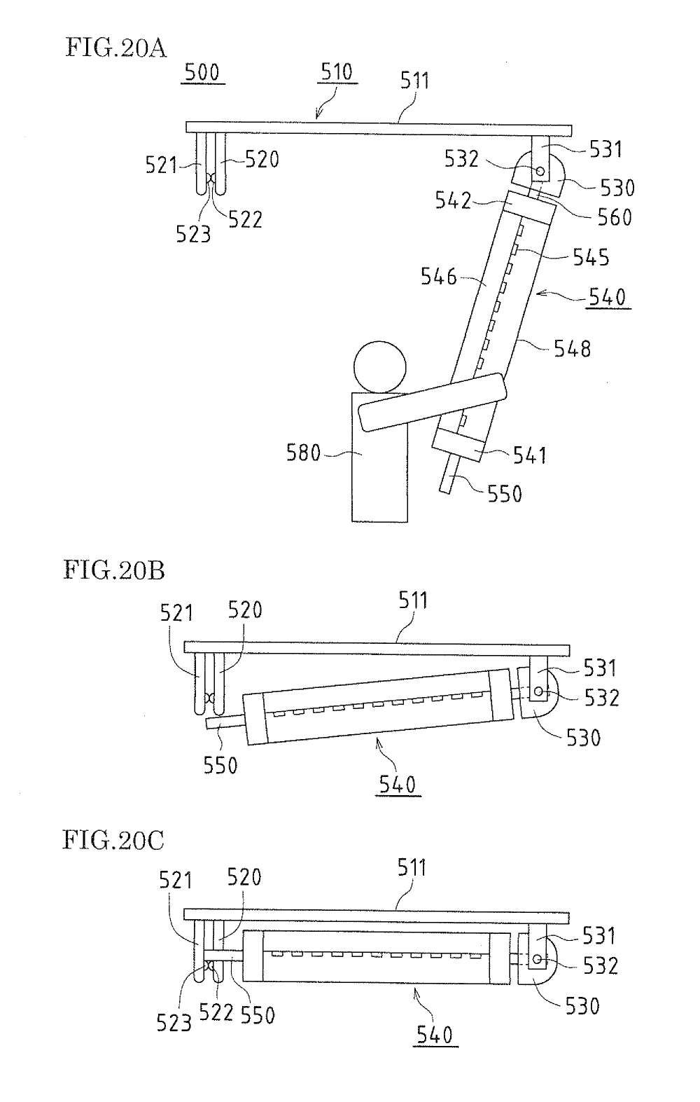

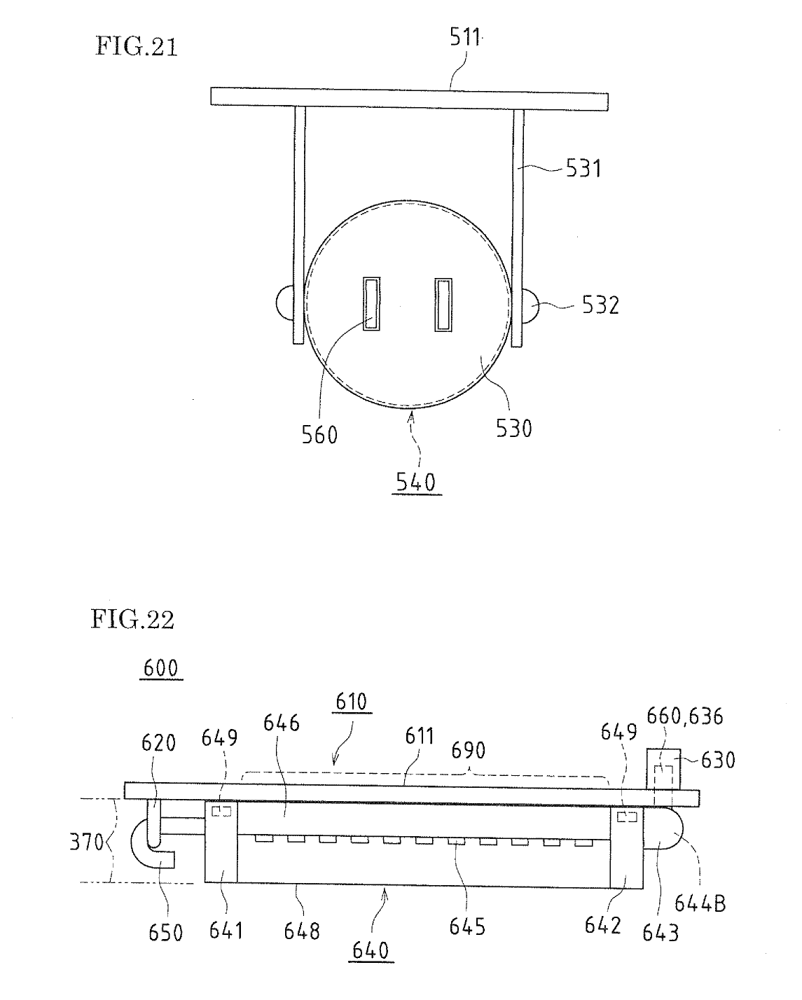

The following is a description of an LED lighting device 500 of Embodiment 5 with reference to FIGS. 20 and 21. Members referenced by 500 numbers in the figures correspond respectively to the members having the same lower two digits and referenced by 100 numbers unless otherwise specified.

Specifically, the LED lighting device 500 includes a holder 510, a holder top plate 511, left holding portions 520 and 521, and a right holding portion 530. An LED lighting apparatus 540 includes a left reinforcing portion 541, a right reinforcing portion 542, LED elements 545, a base portion 546, a cover 548, a left end portion 550, and a plug 560. Other parts of the basic configuration are similar to those of Embodiment 1, and therefore the following description primarily focuses on the main parts of the configuration.

More specifically, the LED lighting device 500 includes the left holding portions 520 and 521 and the right holding portion 530, which are modifications of the left holding portion 420 and the right holding portion 430 of Embodiment 4. The left holding portions 520 and 521 have respectively protrusions 522 and 523 disposed thereon in order to hold the left end portion 550.

FIG. 20A shows the semi-holding state during attachment of the LED lighting apparatus 540 to the holder 510. An operator 580 inserts the plug 560, which also serves as a holding place, into the right holding portion 530 while holding the LED lighting apparatus 540 vertically. Even if the operator 580 loses his/her hold in this condition, the LED lighting apparatus 540 assumes the semi-holding state with respect to the holder 510.

As shown in the right hand side view of FIG. 21, the right holding portion 530 is coupled to a support portion 531 fixed to the holder top plate 511 via a rotary shaft 532. In other words, the right holding portion 530 is pivotable relative to the holder top plate 511 of the holder 510.

The rotary shaft 532 is disposed in the vicinity of the center of the right holding portion 530 and thus reduces the risk of large protrusion from the right side during attachment shown in FIG. 20A. This saves space for a region where the right holding portion 530, the rotary shaft 532, and the support portion 531 are disposed. In addition, the distance between the LED lighting apparatus 540 and the holder top plate 511 can be shortened as compared with Embodiment 4, so they can be brought into contact with each other.

FIG. 20B is a front view showing a state immediately before the left end portion 550 of the LED lighting apparatus 540, serving as a holding place, is inserted between the left holding portions 520 and 521 and held by the protrusions 522 and 523. The left holding portions 520 and 521 are provided respectively with the protrusions 522 and 523, and these protrusions are in contact with each other by the spring force produced in the left holding portions 520 and 521. By pushing the left end portion 550 in between the left holding portions 520 and 521 from the underside (from the floor face side), the left end portion 550 is fitted by insertion between the protrusions 522 and 523.

FIG. 20C is a front view showing the holding state. The left holding portion 520 is held on the protrusions 522 and 523 that are in contact with each other by spring force. Note that although the description was given with the left holding portion 520 and the protrusion 522 being regarded as separate members and the left holding portion 521 and the protrusion 523 being regarded as separate members, a configuration is also possible in which the left holding portion and the protrusion are integrated by, for example, constituting the entire left holding portion 520 (521) of a spring material so as to have a spring force equivalent to the protrusion 522 (523).

As described above, with the LED lighting device 500 according to the present embodiment, the holding portion (the right holding portion 530) is pivotable relative to the holder top plate 511 of the holder 510.

### Embodiment 6

The following is a description of an LED lighting device 600 of Embodiment 6 with reference to FIGS. 22 to 25. Members referenced by 600 numbers in the figures correspond respectively to the members having the same lower two digits and referenced by 100 numbers unless otherwise specified.

Specifically, the LED lighting device 600 includes a holder 610, a holder top plate 611, a left holding portion 620, a right holding portion 630, and plug insertion openings 636. An LED lighting apparatus 640 includes a left reinforcing portion 641, a right reinforcing portion 642, LED elements 645, a base portion 646, a cover 648, a left end portion 650, and a plug 660. Other parts of the basic configuration are similar to those of Embodiment 1, and therefore the following description primarily focuses on the main parts of the configuration.

FIG. 22 is a front view of the LED lighting device 600 of Embodiment 6. The LED lighting apparatus 640 is in contact with the holder top plate 611 of the holder 610. The LED lighting apparatus 640 is of a wide type. Note that the right and left sides are referred to as “end portions” even if the length of the right and left sides (the length in the direction perpendicular to the plane of FIG. 22) of the LED lighting apparatus 640 is longer than the horizontal length (the length in the horizontal direction of FIG. 22) of the LED lighting apparatus 640.

Left Holding Portion

The left holding portion 620 of the holder 610 is in the shape of a loop so that the hook-shaped left end portion 650 of the LED lighting apparatus 640 can be hung thereon. Accordingly, the LED lighting apparatus assumes the semi-holding state with only the left end portion 650 being hung.

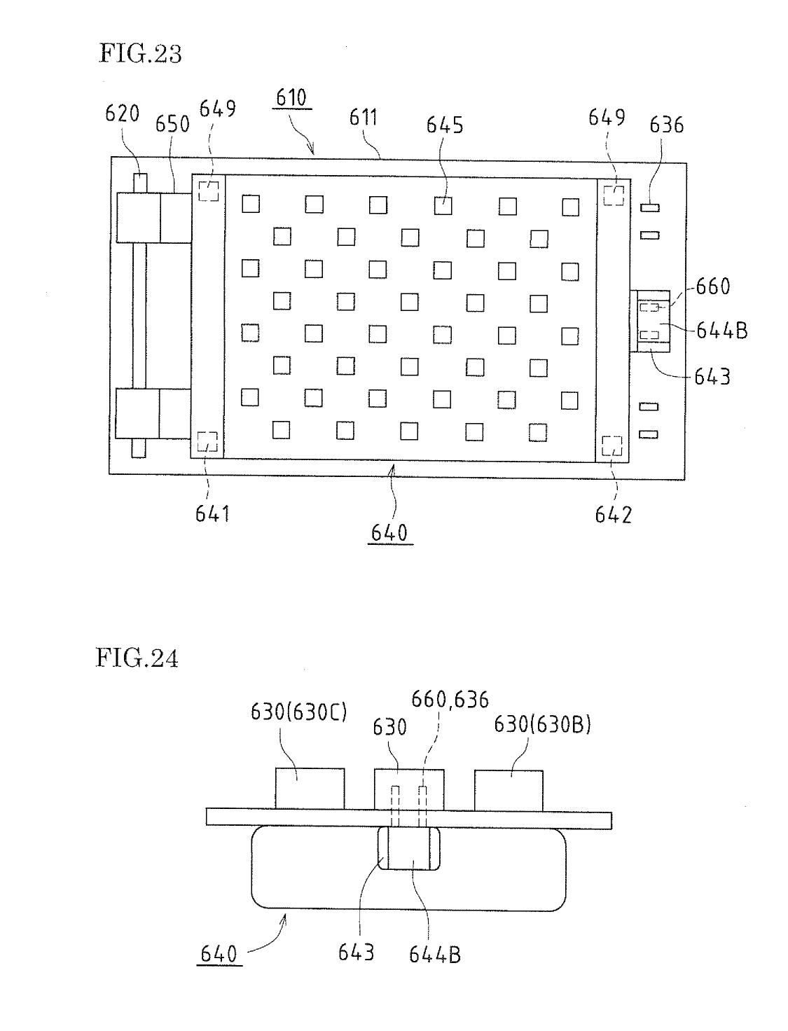

As shown in the bottom view of FIG. 23, the left end portion 650 is divided into two parts in order to hold two places in the width direction.

Right Holding Portion

The right holding portion 630 does not protrude toward the LED lighting apparatus 640 from the holder top plate 611, and protrudes on the upper face side from the holder top plate 611 so as to be disposed on the ceiling side. The plug 660 serves also as a holding place, and the LED lighting apparatus 640 is held by inserting the plug 660 into the plug insertion openings 636 (see FIG. 23).

As shown in the bottom view of FIG. 23, the plug 660 is disposed so as to hold approximately the center of the right end portion.

LED Lighting Apparatus

The holder top plate 611 is constituted by, for example, a magnetic material that is made primarily of iron, and magnets 649 disposed in the LED lighting apparatus 640 are attracted to the holder top plate 611. Accordingly, the holder top plate 611 itself, to which the magnets 649 are attracted, has the main function of the holding portion 610.

In other words, the back face (base portion 646) side of the LED lighting apparatus 640, in particular, the back face (base portion 646) including an element mounting back face region 690 in which the LED elements 645 are mounted, is in good contact with the holder top plate 611. Accordingly, heat generated by the LED elements 645 is favorably conducted into the holder top plate 611.

In the case of a fluorescent lamp, use of magnets requires the greatest attention, such as separating magnets to be used from a fluorescent tube portion, because of the possibility that the magnetic force might disturb discharge, whereas in the present embodiment, the operation of the LED lighting device 600 is unaffected by the use of the magnets 649. However, in the case of using parts such as transformers or coils in the LED lighting apparatus 640, it is desirable that these parts be distanced from the magnets.

Note that the attracting force of the magnets 649 is set to such an extent as to allow the operator to easily remove the LED lighting apparatus 640 from outside. Alternatively, a configuration is possible in which the attracting force is further increased, and a mechanism for serving to distance the magnets 649 from the holder top plate 611 is provided in order to weaken the attracting force of the magnets 649 during removal of the LED lighting apparatus 640.

FIG. 23 shows a bottom view of the LED lighting apparatus 640. The LED lighting apparatus 640, which is wider than long lengths of LED lighting apparatuses (e.g., the LED lighting apparatus 140) similar to fluorescent lamps, becomes an eye-friendly light source that has low illuminance and reduced glare in the case of obtaining the same luminance as obtained with the long LED lighting apparatus 140. In addition, the large-area LED lighting apparatus 640 allows generated heat to be dispersed over a wider area, thereby suppressing a rise in temperature.

FIG. 24 shows a right hand side view of the LED lighting apparatus 640. The plug 660 is pivotable together with a movable portion 644B coupled to the plug support portion 643. During storage of the LED lighting apparatus 640, the plug 660 can fit within the circumscribed rectangular prism 370 (see FIG. 22) of the LED lighting apparatus 640 without protruding upward (on the holder top plate 611 side).

Note that right holding portions 630B and 630C that are not used for the LED lighting apparatus 640 in FIG. 24 will be discussed in the following paragraph.

Application Example of Other LED Lighting Apparatus Using Same Holder

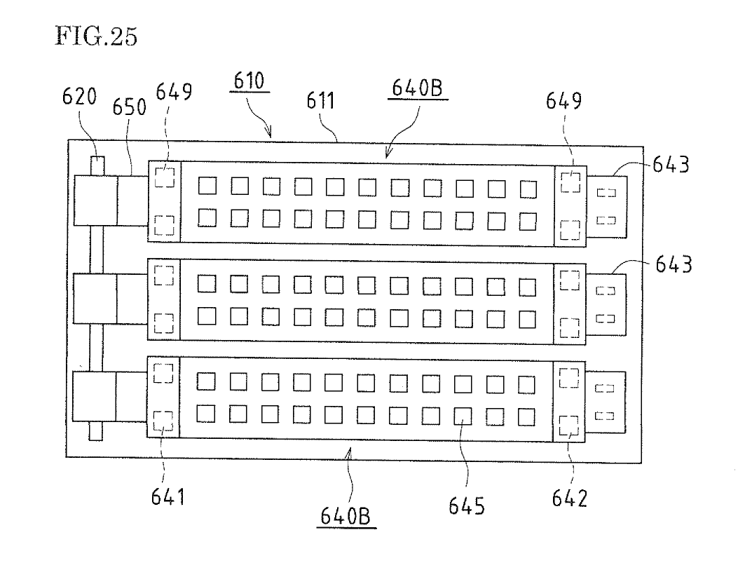

FIG. 25 shows an example in which three LED lighting apparatuses 640B, each having a smaller width than the LED lighting apparatus 640, are attached to the holder 610. In this case, the right holding portions 630B and 630C, which are not used in FIG. 24, are used. Use of the holder 610 enables proper use of LED lighting apparatuses for different cases such as the case of attaching one to three narrow LED lighting apparatuses 640B, or the case of attaching a single wide LED lighting apparatus 640. This allows a flexible combination of LED lighting apparatuses in accordance with the required illuminance.

As described above, with the LED lighting device 600 according to the present embodiment, the back face (the element mounting back face region 690) of the LED element mounting portion (the base portion 646) of the LED lighting apparatus 640 is in contact with the holder top plate 611 of the holder 610.

Furthermore, with the LED lighting device 600 according to the present embodiment, the back face of the LED element mounting portion (the base portion 646) of the LED lighting apparatus 640 is in contact with the holder top plate 611 by the attracting force of the magnets 649.

Additional Notes for Embodiments

The term “end portion” as used in the embodiments refers to a portion that is relatively closer to the end than to the center and in the vicinity of a portion where the LED lighting apparatus is held. Accordingly, it does not necessarily indicate the utmost end of the LED lighting apparatus.

Although the above embodiments were described with the plug at the right end portion serving also as a holding place, the plug may be provided separately from a holding place. Although the plug was described as a two-prong plug used in Japan for commercial alternating-current power supply, it is preferable that the plug shape varies from nation to nation where the plug is used, and therefore, the plug may also be a three- or four-prong plug including an earth line and/or three lines for three-phase alternating current.

Furthermore, commercial alternating-current power supply may be replaced with DC power, and the voltage used in this case is preferably 12 V, 15 V, 48 V, or 340 V, for example. As another alternative, pins that have connection compatibility with pins for conventional fluorescent lamps may be used (although it is preferable that a fluorescent lamp circuit connected to the pins be eliminated).

Furthermore, the right holding portion and the left holding portion described in the embodiments are merely by way of example, and it is not necessary to use a combination of them in one embodiment. Although there are some embodiments in which the LED lighting apparatus and the holder top plate adhere to each other, and other embodiments in which they are separated from each other, it is not necessary to use an example of the right holding portion and the left holding portion in combination with those embodiments.

The present invention can be reduced to practice in various other forms without departing from its spirit or essential features. For this reason, the above-described exemplary embodiments are to all intents and purposes merely illustrative and should not be construed as limiting. The scope of the present invention is defined by the claims and is not in any way restricted by the descriptions of the specification. Furthermore, all variations and modifications of the claims within the scope of equivalency fall within the scope of the present invention.

Also, this application claims prior right on the basis of Japanese Patent Application No. 2009-010338 filed in Japan on Jan. 20, 2009, the content of which is hereby incorporated in its entirety by reference herein.

### INDUSTRIAL APPLICABILITY

The present invention is applicable to an LED lighting device equipped with a removable LED lighting apparatus.

### DESCRIPTION OF REFERENCE NUMERALS

100, 200, 300, 400, 500, 600 LED lighting device
110, 210, 310, 410, 510, 610 Holder
111, 211, 311, 411, 511, 611 Holder Top Plate
120, 220, 320, 420, 520, 521, 620 Left Holding Portion (holding portion)
120j, 320j Left holding body (holding portion)
121, 122, 321, 322 Left holding fastener
130, 230, 330, 430, 530, 630, 630B, 630C Right holding portion (holding portion)
136, 236, 336, 436, 636 Plug insertion opening
137, 337 Release button
140, 240, 240B, 340, 340B, 440, 540, 640, 640B LED lighting apparatus
141, 141B, 241, 241B, 341, 441, 541, 641 Left reinforcing portion (end portion or holding place)
142, 142B, 242, 242B, 342, 442, 542, 642 Right reinforcing portion (end portion or holding place)
145, 245, 345, 445, 545, 645 LED element
146, 246, 346, 446, 546, 646 Base portion (LED element mounting portion)
147, 347 Driving circuit
148, 248, 348, 448, 548, 648 Cover
150, 250, 550 Left end portion (end portion or holding place)
160, 260, 360, 360B, 460, 560, 660 plug (end portion, holding place, or power supply connecting portion)
170 External tangent
180, 280, 380, 480, 580 Operator
182, 382 Working rod tip
221, 221B Left holding spring
231, 231B Right holding spring
243, 343, 343B, 643 Plug support portion
344B, 644B Movable portion
370 Circumscribed rectangular prism (virtual rectangular prism)
431 Right holding and pivoting portion
432 Right holding and fixed portion
522, 523 Protrusion (holding portion)
531 Support portion
532 Rotary shaft
649 Magnet
690 Element mounting back face region (back face of LED element mounting portion)

1. An LED lighting device comprising:
an LED lighting apparatus provided with an LED element; and
a holder including at least a holding portion that holds the LED lighting apparatus and supplies power to the LED lighting apparatus,
wherein a state of connection between the LED lighting apparatus and the holder can be any of a holding state, a semi-holding state, and a separated state, the holding state being a state in which holding places at two end portions of the LED lighting apparatus are held by the holding portion of the holder, the semi-holding state being a state in which one of the holding places at one of the end portions of the LED lighting apparatus is held by the holding portion of the holder, and the separated state being a state in which the LED lighting apparatus and the holder are completely separated from each other.

2. The LED lighting device according to claim 1, wherein in the semi-holding state, the LED lighting apparatus can be held while hanging down from the holding portion due to its own weight.

3. The LED lighting device according to claim 1, wherein the LED lighting apparatus includes a power supply connecting portion in one of the holding places at one of the end portions, but does not include a power supply connecting portion in the other holding place at the other end portion.

4. The LED lighting device according to claim 3, wherein the power supply connecting portion includes at least two connection terminals that have compatibility with a socket for commercial alternating-current power supply, and commercial alternating-current power is supplied from the connection terminals directly to the LED lighting apparatus.

5. The LED lighting device according to claim 3, wherein the power supply connecting portion also serves as one of holding places held by the holding portion of the holder.

6. The LED lighting device according to claim 1, wherein the holding portion is pivotable relative to a holder top plate of the holder.

7. The LED lighting device according to claim 1, wherein the LED lighting apparatus includes a driving circuit for driving the LED element.

8. The LED lighting device according to claim 7, wherein the driving circuit converts commercial alternating-current power into current that has a direct-current component when averaged over time.

9. The LED lighting device according to claim 1, wherein the LED lighting apparatus can be shaped so that during storage, the LED lighting apparatus fits within a portion obtained by extending a virtual rectangular prism circumscribing an external shape of the LED lighting apparatus.

10. The LED lighting device according to claim 1, wherein a back face of an LED element mounting portion of the LED lighting apparatus is in contact with a holder top plate of the holder.

11. The LED lighting device according to claim 10, wherein an attracting force of a magnet brings the back face of the LED element mounting portion into contact with the holder top plate.
